(19) United States
(12) Patent Application Publication
(10) Pub. No.: US 2014/0279754 A1
(43) Pub. Date: Sep. 18, 2014

(54) SELF-EVOLVING PREDICTIVE MODEL

(71) Applicant: THE CLEVELAND CLINIC FOUNDATION, Cleveland, OH (US)

(72) Inventors: Wael K. Barsoum, Bay Village, OH (US); Michael K. Kattan, Cleveland, OH (US); Douglas R. Johnston, Shaker Hts., OH (US); William H. Morris, Shaker Hts., OH (US)

(73) Assignee: THE CLEVELAND CLINIC FOUNDATION, Cleveland, OH (US)

(21) Appl. No.: 14/210,924

(22) Filed: Mar. 14, 2014

Related U.S. Application Data
(60) Provisional application No. 61/792,427, filed on Mar. 15, 2013.

(51) Int. Cl. G06N 7/00; G06N 99/00

(52) U.S. Cl. CPC G06N 7/005; G06N 99/005
USPC 706/12

(57) ABSTRACT

Systems and methods are provided for predicting clinical parameters. A model of a plurality of models having a sufficient accuracy, given a received set of predictors, is selected. A value for a clinical parameter is predicted from the selected model and the set of predictors to provide a predicted value. A value for the clinical parameter is measured, and the model is updated according to the set of predictors and the measured value.

### RELATED APPLICATIONS

The present application claims priority to U.S. Provisional Patent Application Ser. No. 61/792,427 filed Mar. 15, 2013 entitled SELF-EVOLVING PREDICTIVE MODEL under Attorney Docket Number CCF-021257 US PRO. The entire content of this application is incorporated herein by reference in its entirety for all purposes.

TECHNICAL FIELD

This disclosure relates to systems and methods for predicting clinical outcomes and, in particular, is directed to systems and methods for self-evolving predictive models.

### BACKGROUND

Predictive modeling is the process by which a model is created or chosen to try to predict the probability of an outcome. In many cases the model is chosen on the basis of detection theory to try to guess the probability of an outcome given a set amount of input data. Models can use one or more classifiers in trying to determine the probability of a set of data belonging to a given set.

### SUMMARY

A non-transitory computer readable medium stores machine executable instructions executable by a processor to perform a method for predicting clinical parameters. The method includes selecting a model of a plurality of models having a sufficient accuracy given an input set of predictors. A value for a clinical parameter is predicted from the selected model and the set of predictors to provide a predicted value. A value for the clinical parameter is measured, and the model is updated according to the set of predictors and the measured value.

In accordance with another aspect of the present invention, a system is provided for predicting clinical parameters. The system includes a processor and a non-transitory computer readable medium storing machine executable instructions executable by the processor. The machine executable instructions include a plurality of predictive models and a model selector configured to select a first model from a plurality of predictive models according to a set of predictors representing a patient and a set of models each utilizing a predictor not present in the set of predictors representing the patient and predict a value for a clinical parameter from the first model and the set of predictors to provide a predicted value. A sensitivity analysis component is configured to determine an expected accuracy for each of the selected set of models given the set of predictors representing the patient and the predictor not present in the set of predictors and notifying a user via an associated display if the expected accuracy of any of the set of models exceeds an accuracy of the first model by more than a threshold value.

In accordance with yet another aspect of the present invention, a non-transitory computer readable medium stores machine executable instructions executable by a processor to perform a method for predicting clinical parameters. The method includes selecting a model of a plurality of models having a highest accuracy given a received set of predictors and a set of models each utilizing a predictor not present in the set of predictors representing the patient. A value for a clinical parameter is predicted from the selected model and the set of predictors to provide a predicted value. An expected accuracy for each of the set of models is determined given the set of predictors representing the patient and the predictor not present in the set of predictor. A user is notified if an increase in the expected accuracy exceeds a threshold value. A value is measured for the clinical parameter, and the model is updated according to the set of predictors and the measured value.

### BRIEF DESCRIPTION OF THE DRAWINGS

FIG. 1 illustrates an exemplary system for predicting clinical outcomes in accordance with an aspect of the invention.

FIG. 2 illustrates one example of a self-evolving system for predicting patient outcomes in accordance with an aspect of the invention.

FIG. 3 illustrates a methodology for predicting patient outcomes in accordance with an aspect of the invention.

FIG. 4 illustrates a computer system that can be employed to implement systems and methods described herein.

### DETAILED DESCRIPTION

This disclosure relates to systems and methods for predicting clinical outcomes and, in particular, is directed to systems and methods for self-evolving predictive models

Medical modeling can provide useful predicts clinical outcomes, but the predictions are limited by the data provided to the model. For example, it has been determined that even a well designed and well trained model can decay in performance over time in the medical field, as new discoveries invalidate assumptions made in generating the model and obsolete existing training data. Further, even the use of the model to predict clinical outcomes can have an effect on the results based on use of the model, requiring the model to be retrained to account for its own predictions. For example, if a model predicts that a patient's length of stay will be three days for a procedure with a modal stay of four days, preparations that will be made for releasing the patient on the third day can be made before and during the first two days may be timed differently absent the prediction, such that the length of stay is shortened (e.g., outcome improved), at least in part, due to the use of the prediction itself. Finally, a model is only as good as the data provided to it, making a “fire and forget” approach to modeling suboptimal. Accordingly, this disclosure provides a self- evolving model that retrains the model as new data becomes available to ensure that the model remains relevant in the face of both new medical developments as well as its own predictions. Further, the model can be integrated into an electronic medical records system to ensure that the predictions provided are always based on the newest data.

FIG. 1 illustrates an example of a system 10 for predicting clinical outcomes in accordance with an aspect of the invention. In the illustrated example, the system 10 is implemented as machine executable instructions stored on a non-transitory computer readable medium 12 and executed by an associated processor 14. It will be appreciated, however, that the system 10 could instead be implemented as dedicated hardware or programmable logic, or that the non-transitory computer readable medium 12 could comprise multiple, operatively connected, non-transitory computer readable media.

The system 10 can access a database 16 of patient records. Each patient record, for example, can contain biographical data, medical history, medication and allergies, immunization status, laboratory test results, radiology images, vital signs. It will be appreciated that while the database 16 is shown as sharing a medium with other components of the system 10, the database could be stored on one or more other non-transitory computer readable media operatively connected to the processor 14 via a data bus or network connection. For a given clinical prediction model, the database 16 can store both patient records representing a patient for whom a clinical outcome is still unknown as well as patient records representing a patient for whom the clinical outcome has been determined. It will be appreciated that the content of the various patient records will vary, such that the predictors associated with each patient can vary. For example, a given test or procedure may have been performed on one patient in a given clinical scenario but not with respect to another patient. The data representing the results of the test or procedure may therefore be selectively available throughout the patient records associated with the clinical scenario.

Data from the database of patient records 16 can be used to train a plurality of predictive models 20-22 to predict a clinical outcome according to a particular set of predictors. For the purpose of this application, a “model” can refer to a classification or regression model having an associated set of predictors, an associated classification or regression algorithm, a set of parameters consistent with the classification or regression algorithm, and a parameter to be predicted. For example, in a neural network model, parameters can include a number of hidden layers, a number of nodes in each layer, and a matrix of weights for each layer. In a regression model, the parameters can include coefficients for each predictor and an intercept value. It will be appreciated that the predictive models 20-22 can also include models utilizing support vector machines, statistical classifiers, logistic regression, ensemble methods, decision trees, and other supervised learning algorithms, with each algorithm having its own associated parameters that can vary across models.

A model selector 24 can receive a set of predictors 26 from an input source 28 as well as a clinical outcome parameter to be predicted. It will be appreciated that the input source 28 can provide the set of predictors 26 directly or by selecting an existing patient record from the database 16, for example. Each of the plurality of predictive models 20-22 is validated at the time of training using a subset of the available patient records to determine an associated accuracy for the model on each of a set of clinical outcome parameters predicted by the model for one or more associated sets of predictor values. In accordance with an aspect of the invention, the model selector 24 selects a model from the plurality of models having a sufficient (e.g., a highest) accuracy for the desired clinical outcome parameter given the predictors available in the set of predictors 26. That is, the model selector can be programmed to evaluate each of the plurality of models 20-22 relative to the set of predictors 26 to ascertain which of the models is expected to have the highest accuracy.

The selected model is utilized to provide a prediction of a clinical outcome parameter, which is provided to the user at an associated display 30. The predicted parameter can also be stored in the database 16 for later use in evaluating and updating the model. For example, once the clinical outcome is known, an actual value for the clinical outcome parameter can be determined and compared to the predicted clinical outcome parameter to evaluate the accuracy of the model that was selected and utilized for prediction. By accumulating a number of predicted and actual clinical outcome parameters, the accuracy of the model can be regularly updated. It will be appreciated that accuracy, as used herein, can refer to a percentage of correct predictions, an F-score, a percentage of variance accounted for by the predictors, or any other appropriate measure of the accuracy and/or precision of the model.

As a further example, the predicted and actual outcome parameters can be utilized to update each of the disparate types of models. For instance, each of the plurality of models 20-22 can be updated using the accumulated predicted and actual outcome pairs. Specifically, the accumulated data can be used as any or all of training data, validation data, or test data to refine each of the plurality of predictive models 20-22. Accordingly, the effects of the predictions of the model on clinical care can be captured in the updating process, further refining the accuracy of each model. It will be appreciated that this update can occur either periodically or as an accuracy of the model, for example, as measured via a concordance index between predicated and measured outcomes. Where the accuracy of the model falls below a threshold value, the updating process can be guided by subject matter experts to add, change, or remove predictors for the model.

FIG. 2 illustrates one example of a self-evolving system 50 that can be used for predicting patient outcomes or other healthcare related in accordance with an aspect of the invention. The predicted patient outcomes can include, for example, patient length of stay, risk of complications, morbidity, patient satisfaction, a patient diagnosis, patient prognosis, costs of healthcare, readmission rate, patient resource utilization or any other patient outcome information that may be relevant to a healthcare provider, patient or healthcare facility. The system 50 includes a plurality of models 51-62 to predict patient outcomes based on respective sets of predictor variables. The system 50 can select a model according to the available predictors for a given patient to provide the predicted outcome or outcomes for the patient.

Each model 51-62 is can be a classification or regression model having an associated set of predictors, an associated classification or regression algorithm, a set of parameters consistent with the classification or regression algorithm, and a parameter to be predicted. In the illustrated example, the models include a plurality of artificial neural network models (ANN) 51-53, a plurality of regression models (REG) 54-56, a plurality of support vector machine (SVM) models 57-59, and a plurality of random forest models (RF) 60-62. Each model 51-62 can be trained on a training set of existing patient data to derive the associated set of model parameters, and validated against a test set of patient data to determine an associated accuracy (e.g., concordance index) for the respective model. For example, in the neural network and support vector machine models, parameters can include a number of hidden layers, a number of nodes in each layer, and a matrix of weights for each layer. In a regression model, the parameters can include coefficients for each predictor and an offset value. In a random forest model, the parameters can include thresholds or other discriminators determined during training of the various decision trees comprising the models. In one example, the models can have multiple accuracy values, each representing the accuracy of the model given a different set of parameters.

In the example of FIG. 2, the system 50 includes a processor 63 and memory 64, such as can be implemented in a server or other computer. The memory 64 can store computer readable instructions and data. The processor 63 can access the memory 64 for executing computer readable instructions, such as for performing the functions and methods described herein. In the example of FIG. 2, the memory 64 includes computer readable instructions comprising a data extractor 66. The data extractor 66 is programmed to extract patient data from one or more sources of data 68. The sources of data 68 can include for example, an electronic health record (EHR) database as well any other sources of patient data that may contain information associated with a patient, a patient's stay, a patient's health condition, a patient's opinion of a healthcare facility and/or its personnel, and the like. It will be appreciated that the one or more sources of data can be stored on the memory or be available over a data connection, such as a local area network (LAN) or a wide area network (WAN).

The patient data in the sources of data 68 can represent information for a plurality of different categories. By way of example, the categories of patient data utilized in generating a predictive model can include the following: patient demographic data; all patient refined (APR) severity information, APR diagnosis related group (DRG) information, problem list codes, final billing codes, final procedure codes, prescribed medications, lab results and patient satisfaction. Additionally, the patient data utilized in generated a model can include International Classification of Diseases (ICD) codes (e.g., ICD-9 and/or ICD-10 codes), Systematized Nomenclature of Medicine (SNOMED) codes (e.g., SNOMED Clinical Terms (CT) codes), Current Procedural Terminology (CPT) codes, Healthcare Common Procedure Coding System (HCPCS) codes (e.g., HCPCS-level I and HCPCS-level II), durable medical equipment (DME) codes, anatomic correlations and the like. These and other codes, which may vary depending on location or care giver affiliations, thus can be utilized to represent data elements in the active problem list for a given patient encounter. Thus, the data extractor 66 can extract data relevant to any one or more of the categories of patient data from the sources of data 68.

In the illustrated system 50, the extracted data is provided to a categorical filter 72. The categorical filter 72 is programmed to sort a given patient into a class of patients for analysis for a given procedure or disorder as well as a desired outcome for prediction, and thus associates the patient with one of a number of available sets of models (e.g., the set comprising models 51-62). The categorical filter 72 can sort patients according to binary or multi-way categorical variables having a relatively small number of levels. This allows the use of different predictors for patients having varying situations, allowing for a better targeted predictive model. Further, given the large amount of data that could be available in an electronic medical records system, splitting the models predicting a given outcome via one or more categorical filters can allow for the utilization of more data without overfitting a model to the training data. Based on the categorization, the filter 72 associates the patient with one or more of a number of available sets of models (e.g., the set comprising models 51-59). For example, patients with a diagnosed heart condition might have their own set of models for a given outcome (e.g., length of a hospital stay), and patients with Type-II diabetes might have a second set of models for the outcome, and so forth. Effectively, the categorical filtering component 72 provides a coarse selection of a patient model to ensure that the set of models 51-62 under consideration are appropriate to a patient's circumstances, as determined based on the extracted data.

In one example, the sets of models can represent different stages of a patient's stay. For example, there could be a first set of models associated with predicting a patient outcome six hours after a procedure, a second set of models associated with predicting the patient outcome one day after the procedure, a third set of models associated with predicting the patient outcome two days after the procedure, and so on. To account for the effects of predictive modeling on each model, successive sets of models (e.g., the second set of models) can utilize the predicted outcomes from previous sets of models (e.g., the first set of models) as predictors.

Based on set of models associated with the patient by the filter 72, a model selection component 74 is configured to select an appropriate model from the set of models 51-62 according to a set of predictors associated with the model and an associated accuracy of each model. A model can be utilized for a patient for whom less than all of the model predictors are available, with the missing predictors provided via an appropriate imputation methodology, such as multiple imputation with chained equations. It will be appreciated that an associated accuracy of the model can differ when one or more predictors are imputed. Once the model is selected, one or more outcomes predicted by the selected model can be calculated and stored in the memory 64. The predicted outcome(s) can also be output to an operator via an associated display 76. It will be appreciated that predicted outcome can be made repeatedly for a given patient as new predictors become available or when fresh data for one or more predictors becomes available.

The extracted data and selected model are also provided to a sensitivity analysis component 78 for further analysis. In the illustrated implementation, the sensitivity analysis component 78 is configured to determine the impact of any predictors not present in the extracted data on the accuracy of the prediction. For example, by reviewing the selected model and other models from the set of models 51-62, it can be determined if the expected accuracy of the prediction could be significantly increased if one or more additional predictors were present. A significant increase can be defined, for example, as an increase the accuracy of the model exceeding a threshold percentage. Any missing predictors found to have a significant impact on accuracy can be communicated to the operator at the display 76, with the operator having the option to obtain the data (e.g., by ordering a diagnostic procedure, obtaining additional biographical information from the patient, etc.) and restarting the process with the new predictors present.

The sensitivity analysis component 78 can also determine a sensitivity of the outcome to the values of the one or more available predictors. Specifically, the sensitivity analysis component 78 can determine the magnitude of a change in the patient outcome given a change in a given predictor, and alert the operator to predictors that are particularly meaningful in driving the patient outcome. For example, a list of all predictors having an effect greater than a threshold amount for a predetermined change in the value of the predictor can be provided to the operator at the display 76. From this list, the operator can make suggestions to the patient or to caregivers of the patient to improve the likelihood of a positive patient outcome. In one example, the effect of predictor on the outcome can be displayed graphically to simplify conveyance of this information to the patient. To facilitate the sensitivity analysis in large models, the predictors can be categorized into “changeable” and “unchangeable” predictors, with only predictors that are considered to be changeable provided to the operator for review. For example, even if a change in a predictor the patient's family history would have a large impact in the predicted outcome, such a change is infeasible, and thus sensitivity analysis component 78 can disregard it.

The system 50 also includes an update component 80 programmed to periodically update each of the plurality of models 51-62 with new information on patient outcomes from the sources of data 68. For example, when it is determined that an update is desirable for a given model, a plurality of patient records that have been updated with a patient outcome that can be predicted by the model since the last update of the model can be collected and utilized as training data, validation data, and test data.

As an example, the models can be periodically validated, and updated if the predicted outcomes are deviating from the predicted patient outcomes. For example, the deviations from the predicted outcomes can be reviewed via an anomaly detection process, and an update can be performed whenever the deviations from the predictions are inconsistent with an expected distribution. In another example, a concordance index is periodically measured between the predicted clinical outcome and the measured clinical outcome and compared to a threshold value. Whenever the concordance index falls below the threshold, the model can be updated.

It will be appreciated that an update of a given model can be retrained on all new data, all old data, or a combination of old and new data. Similarly, cross-validation and testing of the model can be performed with new data, all old data, or a combination of old and new data, but it will be appreciated that, in accordance with an aspect of the invention, any test data will generally be drawn completely or primarily from new data to ensure that the effects of the use of the model are captured in the accuracy calculated for each model. Once each model has been updated, the new accuracy determined for each model can be provided to the model selection component 74 for selection of future models.

Further, when the model is determined to deviate from measured outcomes, the model outcomes can be reviewed (e.g., by automated methods or by a subject matter expert) to determine if a change to the predictors of the model is necessary. For example, when a deviation of the model from measured outcomes is found to have a relatively constant value over time, the model can be calibrated, for example, by changing an intercept value of a regression or adding an offset from a model's results, to bring the model into accordance with the measured results. Alternatively, where the deviation is more random, the model can be reevaluated to add, change, or remove predictors from the model (e.g., by an expert system or by the subject matter experts). This reevaluation can capture medical advances and environmental or their changes that may not be represented adequately by the current predictors. It will be appreciated, however, that the diversity of the models among a given set of models (e.g., 51) can provide some automated protection against these changes.

In view of the foregoing structural and functional features described above, a method in accordance with various aspects of the invention will be better appreciated with reference to FIG. 3. While, for purposes of simplicity of explanation, the method of FIG. 3 is shown and described as executing serially, it is to be understood and appreciated that the invention is not limited by the illustrated order, as some aspects could, in accordance with the invention, occur in different orders and/or concurrently with other aspects from that shown and described herein. Moreover, not all illustrated features may be required to implement a methodology in accordance with an aspect of the invention. The example method of FIG. 3 can be implemented as machine-readable instructions that can be stored in a non-transitory computer readable medium, such as can be computer program product or other form of memory storage. The computer readable instructions corresponding to the methods of FIG. 3 can also be accessed from memory and be executed by a processing resource (e.g., one or more processor cores).

FIG. 3 illustrates a method 100 for predicting patient outcomes in accordance with an aspect of the invention. It will be appreciated that the methodology can be implemented as dedicated hardware, machine executable instructions stored on a non-transitory computer readable medium and executed by an associated processor, or a combination of these. At 102, a set of predictors representing a patient is received, for example, from a central patient database, as input through an appropriate user interface, or another appropriate means. In one example, the predictors are extracted from a medical database record representing the patient, and include a predictor indicating that the model is being utilized to predict a value for the clinical parameter prior to measuring the value for the clinical parameter. By including a predictor representing use of the model during the treatment of the patient, the model can at least partially account for any effect of the predicted clinical parameter on the course of treatment.

At 104, a model is selected from a plurality of available models. Each model can have one or more associated values representing its accuracy, as the accuracy for a given model can vary according to the predictors available for the model. It will be appreciated that the models can utilize any appropriate supervised or semi-supervised learning algorithms. In one implementation, the plurality of models includes at least one artificial neural network and at least one regression model. At 106, a value is predicted for a clinical parameter from the selected model and the set of predictors to provide a predicted value.

At 108, it is determined if a significant increase in accuracy can be achieved by adding additional predictors. For example, a set of models can be selected from the plurality of models, each utilizing a predictor not present in the set of predictors representing the patient. An expected accuracy can be determined for each of the set of models given the set of predictors representing the patient and the predictor not present in the set of predictors. If an increase in the expected accuracy exceeds a threshold value, the increase in accuracy will be determined to be significant. It will be appreciated that the threshold value can vary across predictors, for example, with the difficulty, medical risk, and/or expense of obtaining the predictor value. If a significant increase in accuracy can be achieved (Y), a user can be notified at 110 before the method proceeds to 112. Otherwise (N), the method can proceed to 112.

At 112, it is determined if a significant change in the predicted outcome can be achieved by changing one or more of the predictors. In some examples, various predictors can include a first group of parameters representing the lifestyle of the patient, the living conditions of the patient, various biometric parameters (e.g., weight, blood pressure, ICD codes, DRG codes, or the like), and any of a number of other variables that are at least partially within the control of the patient and their caretakers. Another group of predictors, such as the patient's medical history or genetics, are infeasible or impossible to change to any significant degree. The sensitivity of the predicted value of the clinical parameter to each of these controllable or “changeable” predictors can be determined as a magnitude of change in the predicted outcome for a given change in a selected parameter (e.g., by a standard percentage or a predetermined amount representing a reasonable lifestyle change). Any predictor for which the change in the predicted outcome exceeds a threshold value can be considered relevant for improving patient outcomes. If it is determined that a significant change can be made in the predicted clinical outcome (Y), a clinical outcome is predicted for the user using the changed predictors at 116. The user is then alerted to the relevant clinical parameters and the predicted outcomes representing the changed predictors are displayed at 116 before the method proceeds to 118. Otherwise (N), the method simply proceeds to 118.

At 118, a value is measured for the clinical parameter. In general, once treatment and care of the patient is concluded, a metric represented by the clinical parameter is measured and recorded. At 120, the model is updated according to the set of predictors and the measured value. In one implementation, the set of predictors and the measured value are incorporated into a training set of data used to retrain the model. In another example, the set of predictors, the predicted value of the clinical parameter and the measured value can be used as part of a test set of data to update and refine the accuracy associated with the model. By consistently updating the model in response to new patient outcomes, the model can remain accurate in the face of changes in the composition of the patient population, advances in relevant technology, and other changes in treatment and care.

FIG. 4 illustrates a computer system 200 that can be employed to implement systems and methods described herein, such as based on computer executable instructions running on the computer system. The user may be permitted to preoperatively simulate the planned surgical procedure using the computer system 200 as desired. The computer system 200 can be implemented on one or more general purpose networked computer systems, embedded computer systems, routers, switches, server devices, client devices, various intermediate devices/nodes and/or stand alone computer systems.

The computer system 200 includes a processor 202 and a system memory 204. Dual microprocessors and other multi-processor architectures can also be utilized as the processor 202. The processor 202 and system memory 204 can be coupled by any of several types of bus structures, including a memory bus or memory controller, a peripheral bus, and a local bus using any of a variety of bus architectures. The system memory 204 includes read only memory (ROM) 206 and random access memory (RAM) 208. A basic input/output system (BIOS) can reside in the ROM 206, generally containing the basic routines that help to transfer information between elements within the computer system 200, such as a reset or power-up.

The computer system 200 can include one or more types of long-term data storage 210, including a hard disk drive, a magnetic disk drive, (e.g., to read from or write to a removable disk), and an optical disk drive, (e.g., for reading a CD-ROM or DVD disk or to read from or write to other optical media). The long-term data storage 210 can be connected to the processor 202 by a drive interface 212. The long-term data storage 210 components provide nonvolatile storage of data, data structures, and computer-executable instructions for the computer system 200. A number of program modules may also be stored in one or more of the drives as well as in the RAM 208, including an operating system, one or more application programs, other program modules, and program data.

A user may enter commands and information into the computer system 200 through one or more input devices 222, such as a keyboard or a pointing device (e.g., a mouse). These and other input devices are often connected to the processor 202 through a device interface 224. For example, the input devices can be connected to the system bus by one or more a parallel port, a serial port or a universal serial bus (USB). One or more output device(s) 226, such as a visual display device or printer, can also be connected to the processor 202 via the device interface 224.

The computer system 200 may operate in a networked environment using logical connections (e.g., a local area network (LAN) or wide area network (WAN) to one or more remote computers 230. A given remote computer 230 may be a workstation, a computer system, a router, a peer device or other common network node, and typically includes many or all of the elements described relative to the computer system 200. The computer system 200 can communicate with the remote computers 230 via a network interface 232, such as a wired or wireless network interface card or modem. In a networked environment, application programs and program data depicted relative to the computer system 200, or portions thereof, may be stored in memory associated with the remote computers 230.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A non-transitory computer readable medium storing machine executable instructions executable by a processor to perform a method for predicting clinical parameters, the method comprising:
selecting a model of a plurality of models having a highest accuracy given a received set of predictors;
predicting a value for a clinical parameter from the selected model and the set of predictors to provide a predicted value;
measuring a value for the clinical parameter; and
updating the model according to the set of predictors and the measured value.

2. The non-transitory computer readable medium of claim 1, the method further comprising:
determining the sensitivity of the predicted value of the clinical parameter to each of a subset of the set of predictors for the selected model as a magnitude of change in the predicted outcome for a given change in a selected parameter; and
displaying each predictor for which the magnitude of the change in the predicted value exceeds a threshold value.

3. The non-transitory computer readable medium of claim 2, wherein the set of predictors for the selected model includes at least a first group of predictors indicated as unchangeable by the patient and a second group of predictors indicated as changeable by the patient, the subset of the set of predictors being selected from the second group of predictors.

4. The non-transitory computer readable medium of claim 1, the method further comprising:
selecting a set of models from the plurality of models, each of the set of models utilizing a predictor not present in the set of predictors representing the patient;
determining an expected accuracy for each of the set of models given the set of predictors representing the patient and the predictor not present in the set of predictors; and
notifying a user if an increase in the expected accuracy exceeds a threshold value.

5. The non-transitory computer readable medium of claim 4, the threshold value being selected according to the predictor not present in the set of predictors.

6. The non-transitory computer readable medium of claim 1, wherein updating the model according to the set of predictors and the measured value comprises utilizing each of the set of predictors, the predicted value of the clinical parameter and the measured value as part of a test set of data to update the accuracy associated with the model.

7. The non-transitory computer readable medium of claim 1, wherein updating the model according to the set of predictors and the measured value comprises retraining the model with a training set of data that includes the set of predictors and the measured value.

8. The non-transitory computer readable medium of claim 1, wherein the set of predictors representing the patient comprises a predictor indicating that the model is being utilized to predict a value for the clinical parameter prior to measuring the value for the clinical parameter.

9. The non-transitory computer readable medium of claim 1, wherein the plurality of models comprises at least one model utilizing an artificial neural network and at least one random forest model.

10. A system for predicting clinical parameters comprising:
a processor; and
a non-transitory computer readable medium storing machine executable instructions executable by the processor, the machine executable instructions comprising:
a plurality of predictive models;
a model selector configured to select a first model from a plurality of predictive models according to a set of predictors representing a patient, and a set of models each utilizing a predictor not present in the set of predictors representing the patient;
a sensitivity analysis component configured to determine an expected accuracy for each of the selected set of models given the set of predictors representing the patient and the predictor not present in the set of predictors and notifying a user via an associated display if the expected accuracy of any of the set of models exceeds an accuracy of the first model by more than a threshold value.

11. The system of claim 10, further comprising an update component configured to updating the first model according to the set of predictors and a measured value for the clinical parameter.

12. The system of claim 11, wherein the update component is configured to retrain the first model with a training set of data that includes the set of predictors and the measured value.

13. The system of claim 11, wherein the update component is configured to utilize each of the set of predictors, a predicted value of the clinical parameter determined from the first model, and the measured value as part of a test set of data to update the accuracy associated with the model.

14. The system of claim 10, the set of predictors comprising at least a first group of predictors indicated as unchangeable by the patient and a second group of predictors indicated as changeable by the patient and the sensitivity analysis component being further configured to determine the sensitivity of a predicted value of the clinical parameter to each of a subset of the second group of predictors as a magnitude of change in the predicted value for a given change in a selected parameter.

15. The system of claim 10, wherein the model selector is configured to impute a value for the predictor not present in the set of predictors via an appropriate imputation algorithm and calculate a predicted value for a clinical parameter from a model of the set of models having a highest accuracy, the set of predictors, and the imputed value.

16. The system of claim 10, wherein the plurality of models comprises at least one model utilizing an artificial neural network and at least one support vector machine.

17. The system of claim 10, wherein the set of predictors includes at least one predictor representing the results of one of a medical test and a clinical procedure.

18. A non-transitory computer readable medium storing machine executable instructions executable by a processor to perform a method for predicting clinical parameters, the method comprising:
selecting a model of a plurality of models having a highest accuracy given a received set of predictors and a set of models each utilizing a predictor not present in the set of predictors representing the patient;
predicting a value for a clinical parameter from the selected model and the set of predictors to provide a predicted value;
determining an expected accuracy for each of the set of models given the set of predictors representing the patient and the predictor not present in the set of predictors;
notifying a user if an increase in the expected accuracy exceeds a threshold value
measuring a value for the clinical parameter; and
updating the model according to the set of predictors and the measured value.

19. The non-transitory computer readable medium of claim 18, the method further comprising:
determining the sensitivity of the predicted value of the clinical parameter to each of a subset of the set of predictors for the selected model as a magnitude of change in the predicted outcome for a given change in a selected parameter; and
displaying each predictor for which the magnitude of the change in the predicted value exceeds a threshold value.

20. The non-transitory computer readable medium of claim 18, wherein the set of predictors representing the patient comprises a predictor indicating that the model is being utilized to predict a value for the clinical parameter prior to measuring the value for the clinical parameter.
